(19) United States
(12) Patent Application Publication
(10) Pub. No.: US 2010/0257341 A1
(43) Pub. Date: Oct. 7, 2010

(54) Selective Execution Dependency Matrix

(75) Inventors: Mary D. Brown, Austin, TX (US); James W. Bishop, Newark Valley, NY (US); William E. Burky, Austin, TX (US); John B. Griswell, JR., Austin, TX (US); Dung Q. Nguyen, Austin, TX (US); Todd A. Venton, Autin, TX (US)

Correspondence Address: IBM Corporation (PEC);c/o Patrick E. Caldwell, Esq., The Caldwell Firm, LLC, PO Box 59655, DALLAS, TX, 75229-0655, US

(73) Assignee: International Business Machines Corporation, Armonk, NY (US)

(21) Appl. No.: 12/417,801

(22) Filed: Apr. 3, 2009

(51) Int. Cl. G06F 9/30

(52) U.S. Cl. 712/216; 712/214; 712/19; 712/E09.016; 712/E09.003

(57) ABSTRACT

A processor having a dependency matrix comprises a first array comprising a plurality of cells arranged in a plurality of columns and a plurality of rows. Each row represents an instruction in a processor execution queue and each cell represents a dependency relationship between two instructions in the processor execution queue. A first latch couples to the first array and comprises a first bit, the first bit indicating a first status. A second latch couples to the first array and comprises a second bit, the second bit indicating a second status. A first read port couples to the first array, comprising a first read wordline and a first read bitline. The first read wordline couples to the first latch and a first column and asserts a first available signal based on the first bit. The first read bitline couples to a first row and generates a first ready signal based on the first available signal and a first cell. A second read port couples to the first array and comprises a second read wordline and a second read bitline. The second read wordline couples to the second latch and the first column and asserts a second available signal based on the second bit. The second read bitline couples to the first row and generates a second ready signal based on the second read wordline and the first cell.

This invention was made with United States Government support under Agreement No. HR0011-07-9-0002 awarded by DARPA. The Government has certain rights in the invention.

### TECHNICAL FIELD

The present invention relates generally to the field of computer processing and instruction scheduling and, more particularly, to a system and method for a selective execution dependency matrix.

### BACKGROUND

Modern electronic computing systems, such as microprocessor systems, typically include a processor and datapath configured to receive and process instructions. Certain systems allow for out of order instruction execution, wherein instructions can issue and be executed out of their order in the underlying program code. An out of order execution system must account for dependencies between instructions.

Generally, a dependency occurs where an instruction requires data from sources that are themselves the result of another instruction. For example, in the instruction sequence:

### ADD $8, $7, $5

### SW $9, (0)$8

The ADD (add) instruction adds the contents of register $7 to the contents of register $5 and puts the result in register $8. The SW (store word) instruction stores the contents of register $9 at the memory location address found in $8. As such, the SW instruction must wait for the ADD instruction to complete before storing the contents of register $8. The SW instruction therefore has a dependency on the ADD instruction. The illustrated dependency is also known as a read-after-write (RAW) dependency.

One common approach to tracking dependencies is a “dependency matrix,” such as that described in U.S. Pat. Nos. 6,065,105 and 6,334,182. Generally, a conventional dependency matrix includes rows and columns. Each bit or element, i.e., the intersection of one row and one column, corresponds to a dependency of an instruction in the issue queue. Each instruction in the issue queue is associated with a particular row in the dependency matrix, with the read-after-write (RAW) dependencies noted by bits set on a given column within that row.

As a given resource becomes available, the dependency matrix clears the column associated with that resource, setting all locations in the column to zero. Once a given instruction (row) has all of its RAW dependencies resolved, i.e., once all columns in that row have been set to zero, then the instruction is ready to issue.

As new instructions enter the issue queue, allocation logic assigns the new instructions to a position within the dependency matrix. The dependency matrix logic checks sources for that instruction against a destination register file. A match between an entering instruction's source and a pending instruction's destination indicates that the entering instruction is dependent on the pending entry, and the dependency matrix logic sets the bit in the appropriate position in the dependency matrix. The newly entered instruction will not issue from the issue queue until after the instruction on which it depends has issued, as indicated by the dependency matrix.

In most systems, the “issue-to-issue latency” is the minimum number of clock cycles between the time a producer instruction issues and the time a dependent consumer instruction can issue. A given producer instruction may have a different issue-to-issue latency for different classes of dependent consumer instructions. For example, a subtract instruction dependent upon an add instruction may be able to execute one cycle after the add instruction, whereas a load instruction may not be able to execute until two cycles after the add instruction. Issue-to-issue latencies can also vary between execution units. For example, an add instruction executing on a first execution unit may have an issue-to-issue latency of one cycle for dependent consumer instructions issued to the first execution unit, and an issue-to-issue latency of two cycles (or more) for dependent consumer instructions issued to a second execution unit.

Addressing the problem of variable issue-to-issue latencies has been a challenge in modern architecture design. Current solutions use separate instruction queues for instructions with different issue-to-issue latencies. Implementing separate queues requires additional area and hardware complexity. Other solutions broadcast an instruction tag between the instruction queue partitions, which requires further hardware complexity. Other solutions latch the “available” lines, which also adds hardware complexity. Still other solutions add bits to the instructions to indicate a preset issue-to-issue latency, which also increases hardware area and complexity.

Therefore, there is a need for a system and/or method for a dependency matrix that addresses at least some of the problems and disadvantages associated with conventional systems and methods.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

A processor having a dependency matrix comprises a first array comprising a plurality of cells arranged in a plurality of columns and a plurality of rows. Each row represents an instruction in a processor execution queue and each cell represents a dependency relationship between two instructions in the processor execution queue. A first latch couples to the first array and comprises a first bit, the first bit indicating a first status. A second latch couples to the first array and comprises a second bit, the second bit indicating a second status. A first read port couples to the first array, comprising a first read wordline and a first read bitline. The first read wordline couples to the first latch and a first column and asserts a first available signal based on the first bit. The first read bitline couples to a first row and generates a first ready signal based on the first available signal and a first cell. A second read port couples to the first array and comprises a second read wordline and a second read bitline. The second read wordline couples to the second latch and the first column and asserts a second available signal based on the second bit. The second read bitline couples to the first row and generates a second ready signal based on the second read wordline and the first cell.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram showing an instruction dependency tracking system in accordance with a preferred embodiment;

FIG. 2 illustrates a block diagram showing an instruction dependency tracking system in accordance with a preferred embodiment;

FIG. 3 illustrates a high-level flow diagram depicting logical operational steps of an improved instruction dependency tracking method, which can be implemented in accordance with a preferred embodiment; and

FIG. 4 illustrates an example computer system that can be configured in accordance with a preferred embodiment.

### DETAILED DESCRIPTION

The particular values and configurations discussed in these non-limiting examples can be varied and are cited merely to illustrate at least one embodiment and are not intended to limit the scope of the invention.

In the following discussion, numerous specific details are set forth to provide a thorough understanding of the present invention. Those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, user interface or input/output techniques, and the like, have been omitted inasmuch as such details are not considered necessary to obtain a complete understanding of the present invention, and are considered to be within the understanding of persons of ordinary skill in the relevant art.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

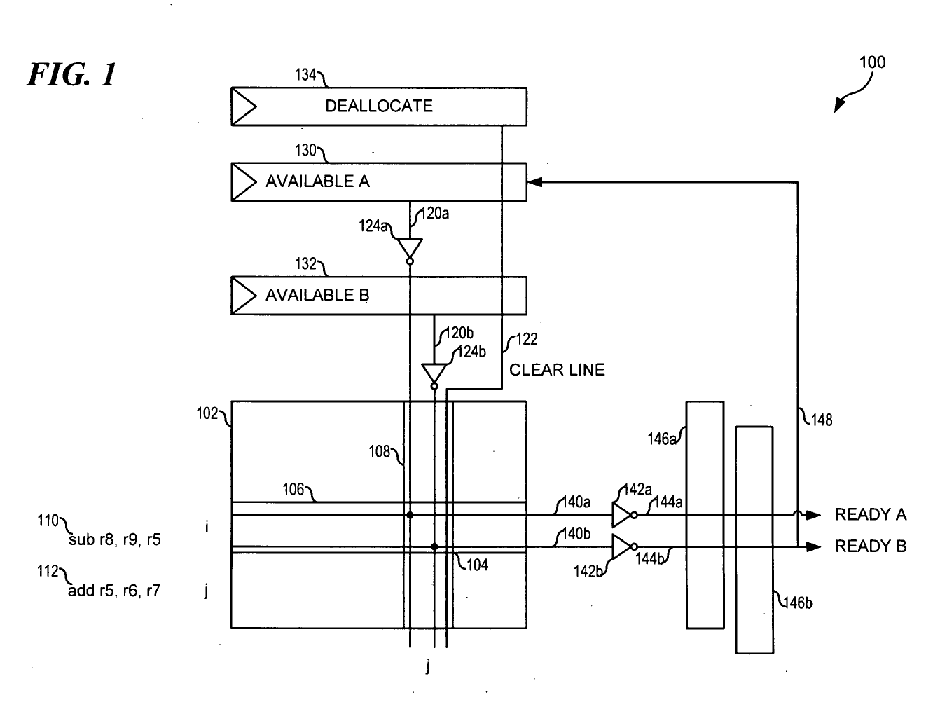

Referring now to the drawings, FIG. 1 illustrates an embodiment of an exemplary instruction dependency tracking system 100. System 100 includes dependency matrix 102. Generally, dependency matrix 102 is an otherwise conventional dependency matrix, modified as described herein. In one embodiment, dependency matrix 102 supports scheduling instructions according to the availability of their register dependences, as described in more detail below. In one embodiment, system 100 implements matrix 102 as a register file. As illustrated, dependency matrix 102 comprises a plurality of cells, such as exemplary cell 104, which hold instruction dependency information.

In particular, cell 104 is disposed at the intersection of row “l” 106 and column “j” 108. Generally, horizontal rows such as row 106 track the dependencies of a single instruction, such as instruction 110, for example, which depends on instruction 112. Generally, vertical columns, such as column 108, indicate the source instructions on which the dependent instruction depends, such as instruction 112, for example. As illustrated, the SUB instruction (110) depends on the result of the ADD instruction (112). As shown, the SUB instruction is in row “l” 106, and the ADD instruction is in row j. Accordingly, matrix 102 sets bit (i,j) (cell 104) to 1, indicating the dependence between the two instructions 110 and 112. Where there is no dependency (such as between instruction 110 and the instruction in row “m” (not shown), the cell formed by row 106 and column “m” (not shown) is “clear” or logic 0, indicating no dependency. Dependency matrix 102 sets and clears each cell as the status of the dependencies change, typically as instructions issue and execute.

In one embodiment, each cell in matrix 102 couples to two read wordlines. For example, in the illustrated embodiment, matrix 102 includes a first read wordline 120a and a second read wordline 120b. Generally, each read wordline is in a logic high state while the instruction represented by that column remains unexecuted. When the result produced by an instruction becomes available, the associated read wordline changes to a logic low state, driven low by system 100.

In the illustrated embodiment, system 100 includes an “AVAILABLE A” latch 130 and an “AVAILABLE B” latch 132. Generally, latch 130 and latch 132 are otherwise conventional latches, configured to indicate which instructions' results are available for waking dependent consumers, as described in more detail below. In one embodiment, when system 100 enqueues an instruction, latch 130 and latch 132 each set a corresponding bit to logic low, indicating that the instruction's results are not yet available for dependent consumers (if any).

In the illustrated embodiment, the bit output feeds the corresponding read wordline, which is then inverted for use by dependency matrix 102. As shown, latch 130 couples to an otherwise conventional inverter 124a, the output of which comprises read wordline 120a. Similarly, latch 132 couples to an otherwise conventional inverter 124b, the output of which comprises read wordline 124b. Thus, when an instruction's results are not available, its corresponding read wordline is in a logic high state. As described in more detail below, when an instruction's results are available, latch 130 and latch 132 set the corresponding bit to logic high, which output is inverted (by inverters 124a and 124b, for example), thereby driving the read wordlines into a logic low state. In one embodiment, the read wordlines and read outputs determine the eligibility for an instruction to be scheduled for execution.

In one embodiment, each row of matrix 102 includes a first read output and a second read output associated with that row. For example, row “i” includes read output, bit i 140a and bit i 140b. Generally, read output 140a couples to the read wordlines that couple to latch 130 (e.g., read wordline 120a) and read output 140 be couples to the read wordlines that couple to latch 132 (e.g., read wordline 120b). In the illustrated embodiment, the read output for each row is in a logic high state (or “on”) if, for any bit j of the row, where the bit j contains a “1”, the associated read wordline for that bit j is also on. As such, read output 140a, for example, is on when read wordline 120a is on. Similarly, read output 140b is on when read wordline 120b is on. Thus, read output 140 is on when any source for an instruction on which the row's instruction depends (i.e., the producer instruction) is not available, or as indicated by the corresponding latch, as described in more detail below.

In the illustrated embodiment, read output 140a couples to an otherwise conventional inverter 142a. The output of inverter 142a is a ready “A” signal 144a, which indicates whether the corresponding instruction is ready to be scheduled for execution (according to latch 130). In one embodiment, each read output “A” of matrix 102 together comprises a ready vector “A” 146a. So configured, ready vector 146a indicates which instructions represented in matrix 102 are ready to be issued for execution.

Similarly, read output 140b couples to an otherwise conventional inverter 142b. The output of inverter 142b is a ready “B” signal 144b, which indicates whether the corresponding instruction is ready to be scheduled for execution (according to latch 132). In one embodiment, each read output “B” of matrix 102 together comprises a ready vector “B” 146b. So configured, ready vector 146b indicates which instructions represented in matrix 102 are ready to be issued for execution. In the illustrated embodiment, ready vector 146b also couples to latch 130 thorough link 148. In an alternate embodiment, ready vector 146b does not couple to latch 130.

In one embodiment, each column of dependency matrix 102 includes a clear line. For example, column 108 includes clear line 122. In the illustrated embodiment, system 100 includes a “DEALLOCATE” latch 134, coupled to clear line 122. Generally, latch 134 is an otherwise conventional latch, configured to indicate which instructions have been deallocated from the instruction queue (typically because they have been executed), and therefore which columns in matrix 102 can be cleared of dependency information associated with the deallocated instruction. In one embodiment, when system 100 executes an instruction, latch 134 sets a bit corresponding to that executed instruction. The clear line 122 associated with the bit clears the column associated with the deallocated instruction. Generally, latch 134 indicates which instructions are being deallocated from the queue, and the latch 134 bitwise output forms the clear wordlines, such as clear line 122.

Thus, in one embodiment, system 100 asserts clear line 122, at some time after an instruction is deallocated from the queue, and before re-allocating the now-vacant entry to another instruction. As described above, asserting the clear wordline clears out the contents of the associated column. As such, system 100 assists in ensuring that there are no false dependences on the younger instructions subsequently allocated.

Thus, in one embodiment, each cell of matrix 102 couples to a read wordline “a” fed by an “AVAILABLE A” latch and a read wordline “b” fed by an “AVAILABLE B” latch. Each cell (and row) also couples to a read output “a” feeding a ready “A” vector and a read output “b” feeding a ready “B” vector. Thus, for an instruction in row “i”, for example, two ready vectors indicate the instruction's ready status, ready “A” and ready “B”, which are formed based on the contents of the associated latch 130 and latch 132. In one embodiment, system 100 sets the bits in latch 130 and latch 132 based on different availability criteria.

For example, in typical prior art systems, the “available” latches indicate whether an instruction's sources are available to the instruction. In one embodiment, however, system 100 can be configured to set the bits in latch 130 according to a speculative scheduling heuristic (i.e., the sources are not confirmed ready) and to set the bits in latch 132 according to a non-speculative scheduling heuristic (i.e., the sources are known to be ready). So configured, system 100 offers technical advantages over prior art systems and methods.

Generally, an instruction's “issue-to-issue latency” is the minimum number of clock cycles between the cycle in which a producer instruction issues and the cycle in which a dependent consumer instruction can issue. A given producer instruction may have a different issue-to-issue latency for different classes of dependent consumer instructions. For example, a subtract instruction dependent upon an add instruction may be able to execute one cycle after the add instruction, whereas a load instruction may not be able to execute until two cycles after the add instruction. Issue-to-issue latencies can also vary between execution units. For example, an add instruction executing on a first execution unit may have an issue-to-issue latency of one cycle for dependent consumer instructions issued to the first execution unit, and an issue-to-issue latency of two cycles (or more) for dependent consumer instructions issued to a second execution unit.

In a particular example, in one embodiment, when system 100 executes add instruction 112, system 100 sets the corresponding bit in latch 130 according to the issue-to-issue latency of add instruction 112 on the scheduled execution unit. In one embodiment, the issue-to-issue latency is speculative, and assumes that load instructions hit in the cache and that the producer instructions do not get rejected after issue. In one embodiment, system 100 sets the corresponding bit in latch 132 according to the larger of the issue-to-issue latency and the time at which the issue of the consumer instruction is known to be non-speculative. For example, in one embodiment, if an add instruction is dependent on a load instruction, system 100 does not set the corresponding bit in latch 132 (indicating that the sources are ready) until the load is known to have hit in the cache.

System 100 can also be configured to set latch 130 and latch 132 according to other heuristics. For example, in one embodiment, system 100 sets latch 130 according to the instruction's latency on a first execution unit and sets latch 132 according to the instruction's latency on a second execution unit. So configured, the two ready outputs A and B indicate the instruction's readiness for execution on the first and second execution units, respectively.

In one embodiment, system 100 sets a latch by setting a bit in the latch array corresponding to the instruction when the instruction is considered ready according to the operative heuristic. For example, in a speculative issue, system 100 considers an instruction “ready” before system 100 knows whether that instruction's target execution unit or sources are, in fact, available—that is, before the instruction is actually ready to execute. As such, in one embodiment, system 100 sets a latch “according to a latency” by setting the corresponding latch bit high after a number of clock cycles corresponding to the latency.

As described above, in one embodiment, ready B vector 146b couples to latch 130 (though link 148). In one embodiment, ready A vector 146a is a speculative ready vector and ready B vector 146b is a non-speculative ready vector. As such, in one embodiment, when an instruction issue is known to be non-speculative, system 100 sets the corresponding bit in latch 132, which propagates to ready B vector 146b. As ready B vector 146b indicates the instruction issue is known to be non-speculative, in one embodiment, ready B vector 146b sets the corresponding bit in latch 130 as the “speculative” issue is now certain, thereby also propagating to ready A vector 146a. Thus, in one embodiment, when an instruction issue is known to be non-speculative, both ready A vector 146a and ready B vector 146b indicate that the instruction is ready for issue.

As illustrated, system 100 includes two “read ports”: read wordline 120a and read output 140a, and read wordline 120b and read output 140b. In an alternate embodiment, system 100 can be configured with three or more read ports.

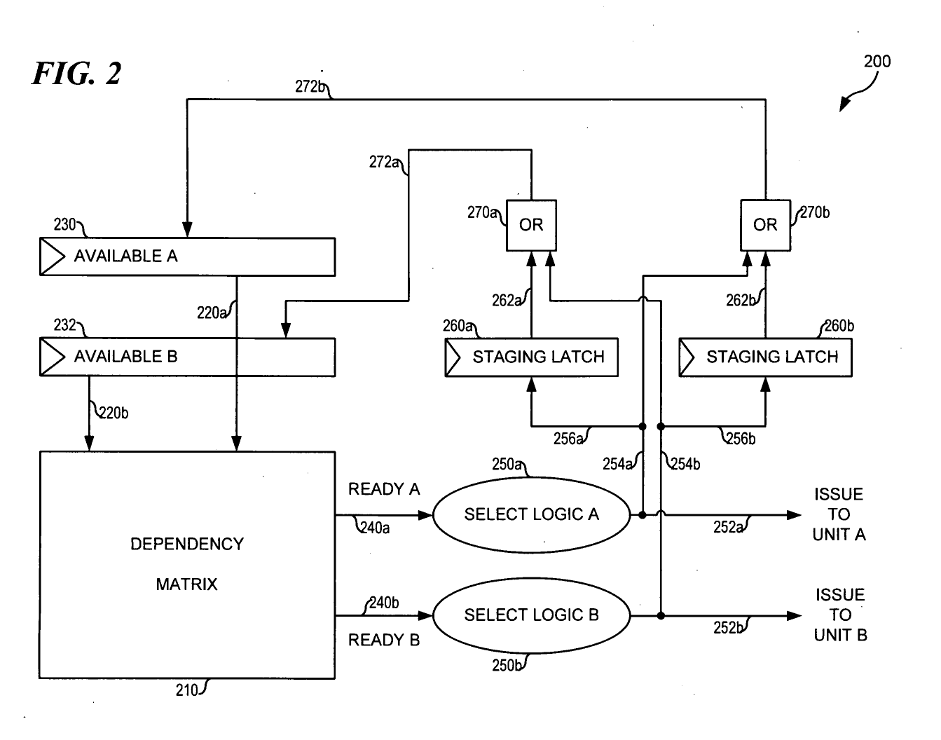

FIG. 2 illustrates another embodiment of an instruction dependency tracking system 200. Generally, system 200 operates substantially as system 100, modified as described below. Thus, system 200 includes components configured substantially as described with respect to FIG. 1: dependency matrix 210, read wordline “A” 220a; read wordline “B” 220b; “AVAILABLE A” latch 230; “AVAILABLE B” latch 232; ready “A” vector 240a; and ready “B” vector 240b.

In the illustrated embodiment, system 200 includes select logic “A” 250a and select logic “B” 250b. Ready “A” vector 240a couples to logic 250a and ready “B” vector 240b couples to logic 250b. Generally, logic 250a and logic 250b are circuits or other logic configured to select from among the instructions represented in the associated ready vector. For example, in one embodiment, logic 250a and logic 250b include qualifiers to gate their associated ready vector with type bits. In one embodiment, the type bits identify certain instruction types that can only be issued on a particular execution unit. In one embodiment, logic 250a and logic 250b comprise staging latches.

Generally, in operation, logic 250a selects one of the instructions represented by vector 240a for execution on execution unit “A” (not shown). In the illustrated embodiment, logic 250a couples to execution unit “A” through link 252a. In one embodiment, logic 250a selects an instruction for execution based on a pre-determined selection heuristic. In one embodiment, the selection heuristic is configured based on the level of speculation associated with the ready vector 240a. For example, in one embodiment, logic 250a selects the qualified instruction with the highest probability of a successful speculative issue. In one embodiment, logic 250a selects the oldest qualified instruction.

Similarly, in one embodiment, logic 250b selects one of the instructions represented by vector 240b for execution on execution unit “B” (not shown). In the illustrated embodiment, logic 250b couples to execution unit “B” through link 252b. In one embodiment, logic 250b selects an instruction for execution based on a pre-determined selection heuristic. In one embodiment, the selection heuristic is configured based on the level of speculation associated with the ready vector 240b. For example, in one embodiment, logic 250b selects the qualified instruction with the lowest probability of a successful speculative issue. In one embodiment, logic 250b selects the oldest qualified instruction.

In one embodiment, system 200 can also be configured to introduce a pre-determined delay based on an issue-to-issue latency between two execution units. For example, system 200 also includes staging latch 260a and staging latch 260b. Staging latch 260a is an otherwise conventional instruction latch, and couples to logic 250a through link 254a and link 256a. Staging latch 260b is an otherwise conventional instruction latch, and couples to logic 250b through link 254b and link 256b.

In the illustrated embodiment, each staging latch also couples to an OR gate. Specifically, latch 260a couples to an otherwise conventional OR gate 270a through link 262a. Similarly, latch 260b couples to an otherwise conventional OR gate 270b through link 262b. OR gate 270a couples to AVAILABLE B latch 232 through link 272a. OR gate 270b couples to AVAILABLE A latch 230 through link 272b.

Generally, in one embodiment, logic 250a and logic 250b stage instructions for issue one cycle before the instructions actually issue to the respective execution unit. As such, in one embodiment, system 200 sets the corresponding bit in the complementary available latch if the instruction issues from its designated select logic or is staged by the complementary select logic. For example, in one embodiment, system 200 sets the available bit in latch 232 if the corresponding instruction issues from select logic “B” 250b or is staged in latch 260a by select logic “A” 250a. Similarly, in one embodiment, system 200 sets the available bit in latch 230 if the corresponding instruction issues from select logic “A” 250a or is staged in latch 260b by select logic “B” 250b. As such, in one embodiment, an instruction receives an indication that its sources are ready that is determined in part by the execution unit on which the producer instruction issues.

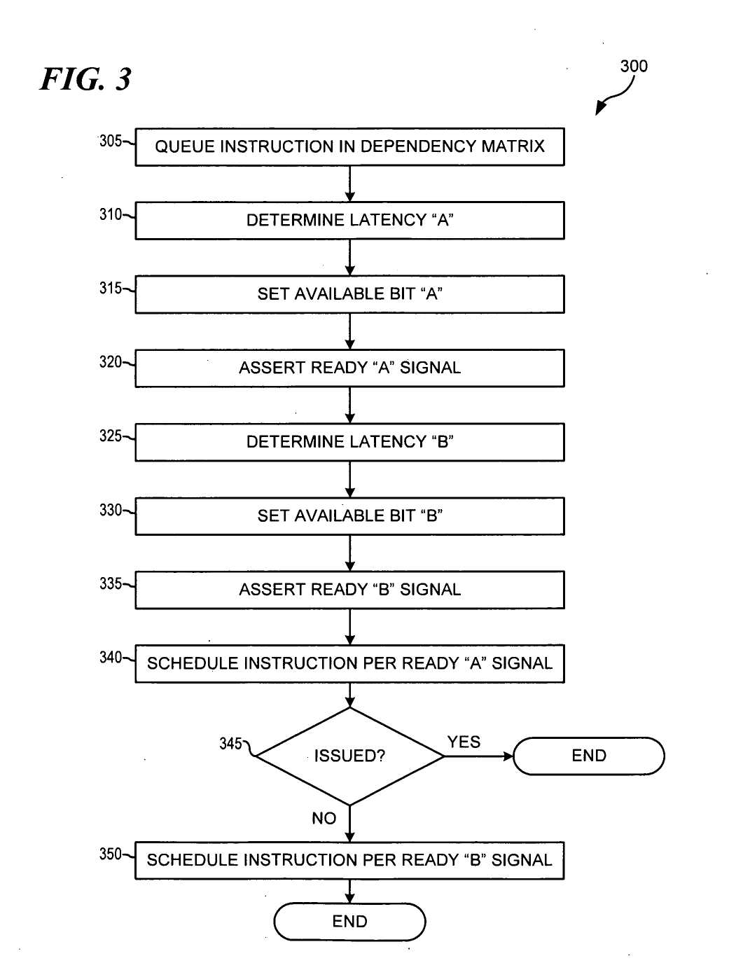

FIG. 3 illustrates one embodiment of a method for improved instruction dependency tracking and scheduling. Specifically, FIG. 3 illustrates a high-level flow chart 300 that depicts logical operational steps performed by, for example, system 100 of FIG. 1 or system 200 of FIG. 2, which may be implemented in accordance with a preferred embodiment.

As indicated at block 305, the process begins, wherein system 100 queues an instruction. In one embodiment, system 100 sets dependency information for the instruction in an empty row of dependency matrix 102, row “j”, tracking any dependencies the instruction may have. Next, as indicated at block 310, system 100 determines a first latency, latency “A”, for the instruction.

Next, as indicated at block 315, system 100 sets a first available bit, in first “AVAILABLE” latch “A” based on latency “A”. Next, as indicated at block 320, system 100 asserts a first ready signal, ready “A” signal, based on the bit set in latch “A”.

Next, as indicated at block 325, system 100 determines a second latency, latency “B”, for the instruction. Next, as indicated at block 330, system 100 sets a second available bit, in second “AVAILABLE” latch “B” based on latency “B”. Next, as indicated at block 335, system 100 asserts a second ready signal, ready “B” signal, based on the bit set in latch “B”.

Next, as indicated at block 340, system 100 schedules the instruction according to the ready “A” signal. Next, at decisional block 345, system 100 determines whether the instruction issued according to the scheduling action. If at decisional block 345 system 100 determines that the instruction issued according to the scheduling action, the process continues along the YES branch and the process ends.

If at decisional block 345 system 100 determines that the instruction did not issue according to the scheduling action, the process continues along the NO branch to block 350. Next, as indicated at block 350, system 100 schedules the instruction according to the ready “B” signal and the process ends.

Thus, generally, systems 100 and 200 provide improved instruction tracking and scheduling as compared to prior art systems and methods. Accordingly, the disclosed embodiments provide numerous advantages over other methods and systems, as described herein.

For example, systems 100 and 200 can be configured to assign a higher selection priority for instructions woken up non-speculatively. As such, systems 100 and 200 can increase performance by reducing the number of mis-speculations that delay truly-ready instructions from issuing. Additionally, systems 100 and 200 can be configured to gate off the speculative ready vector during periods of high amounts of mis-speculation. Thus, systems 100 and 200 increase performance by selecting non-speculative ready instructions earlier than instructions with a high probability of mis-speculation, which can improve performance.

Additionally, systems 100 and 200 can be configured to support a number of selection heuristics. For example, in one embodiment, systems 100 and 200 can be configured with the output of the non-speculative port coupled to the input of the speculative port, bypassing the select logic. As such, systems 100 and 200 can reduce the possibility of a long chain of dependent instructions waking up speculatively, as the chain depth is thus limited to 1.

Accordingly, systems 100 and 200 offer advantages over prior art systems and methods, for example, such as that described in U.S. Pat. No. 6,988,185, issued to Stark, IV, et al. For example, by having two separate ready vector outputs, “speculative” and “non-speculative”, systems 100 and 200 can be configured to grant selection priority to the non-speculative ready vector. Additionally, the second read port of systems 100 and 200 eliminate the need for a special OR gate in front of the read port latches, which can improve timing, especially in cases where the select logic is in the critical path.

Additionally, systems 100 and 200 can be configured to avoid “pileups,” in which the system must reject a long chain of dependent instructions that were woken up speculatively based on a mis-speculated producer instruction. Systems 100 and 200 can be configured to distinguish between speculatively-ready and truly-ready instructions, and therefore can also gate off the speculatively-ready vector, thereby stopping a chain of piled-up instructions. Thus, the embodiments described herein offer numerous advantages over prior art systems and methods.

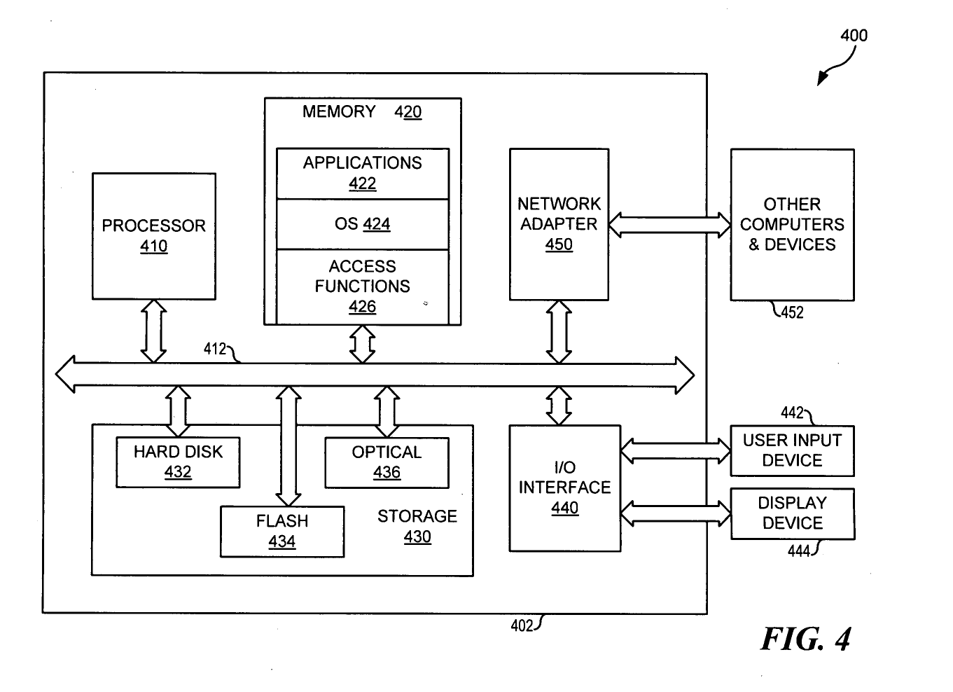

FIG. 4 is a block diagram providing details illustrating an exemplary computer system employable to practice one or more of the embodiments described herein. Specifically, FIG. 4 illustrates a computer system 400. Computer system 400 includes computer 402. Computer 402 is an otherwise conventional computer and includes at least one processor 410. Processor 410 is an otherwise conventional computer processor and can comprise a single-core, dual-core, central processing unit (PU), synergistic PU, attached PU, or other suitable processors.

Processor 410 couples to system bus 412. Bus 412 is an otherwise conventional system bus. As illustrated, the various components of computer 402 couple to bus 412. For example, computer 402 also includes memory 420, which couples to processor 410 through bus 412. Memory 420 is an otherwise conventional computer main memory, and can comprise, for example, random access memory (RAM). Generally, memory 420 stores applications 422, an operating system 424, and access functions 426.

Generally, applications 422 are otherwise conventional software program applications, and can comprise any number of typical programs, as well as computer programs incorporating one or more embodiments of the present invention. Operating system 424 is an otherwise conventional operating system, and can include, for example, Unix, AIX, Linux, Microsoft Windows™, MacOS™, and other suitable operating systems. Access functions 426 are otherwise conventional access functions, including networking functions, and can be include in operating system 424.

Computer 402 also includes storage 430. Generally, storage 430 is an otherwise conventional device and/or devices for storing data. As illustrated, storage 430 can comprise a hard disk 432, flash or other volatile memory 434, and/or optical storage devices 436. One skilled in the art will understand that other storage media can also be employed.

An I/O interface 440 also couples to bus 412. I/O interface 440 is an otherwise conventional interface. As illustrated, I/O interface 440 couples to devices external to computer 402. In particular, I/O interface 440 couples to user input device 442 and display device 444. Input device 442 is an otherwise conventional input device and can include, for example, mice, keyboards, numeric keypads, touch sensitive screens, microphones, webcams, and other suitable input devices. Display device 444 is an otherwise conventional display device and can include, for example, monitors, LCD displays, GUI screens, text screens, touch sensitive screens, Braille displays, and other suitable display devices.

A network adapter 450 also couples to bus 412. Network adapter 450 is an otherwise conventional network adapter, and can comprise, for example, a wireless, Ethernet, LAN, WAN, or other suitable adapter. As illustrated, network adapter 450 can couple computer 402 to other computers and devices 452. Other computers and devices 452 are otherwise conventional computers and devices typically employed in a networking environment. One skilled in the art will understand that there are many other networking configurations suitable for computer 402 and computer system 400.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

One skilled in the art will appreciate that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A processor having a dependency matrix, comprising:
a first array comprising a plurality of cells arranged in a plurality of columns and a plurality of rows;
wherein each row represents an instruction in a processor execution queue; and
wherein each cell in the first array represents a dependency relationship between two instructions in the processor execution queue;
a first latch coupled to the first array and comprising a first bit, the first bit indicating a first status;
a second latch coupled to the first array and comprising a second bit, the second bit indicating a second status;
a first read port coupled to the first array, comprising a first read wordline and a first read bitline;
wherein the first read wordline couples to the first latch and a first column and is configured to assert a first available signal based on the first bit;
wherein the first read bitline couples to a first row and is configured to generate a first ready signal based on the first available signal and a first cell; and
wherein the first cell is disposed at an intersection of the first column and the first row; and
a second read port coupled to the first array, comprising a second read wordline and a second read bitline;
wherein the second read wordline couples to the second latch and the first column and is configured to assert a second available signal based on the second bit; and
wherein the second read bitline couples to the first row and is configured to generate a second ready signal based on the second read wordline and the first cell.

2. The processor of claim 1, wherein the second ready signal couples to the first latch and is configured to set the first bit.

3. The processor of claim 1, further comprising:
select logic coupled to the second read port, the first latch, and a first execution unit, and
wherein the select logic is configured to select between the first latch and the first execution unit and to transmit the second ready signal based on the selection.

4. The processor of claim 1, wherein the first ready signal comprises a speculative ready vector and the second ready signal comprises a non-speculative ready vector.

5. The processor of claim 1, wherein the first read port issues to a first execution unit and the second read port issues to a second execution unit.

6. The processor of claim 1, wherein the dependency matrix is further configured to set the first bit according to a first latency determination and to set the second bit according to a second latency determination.

7. The processor of claim 1:
wherein the dependency matrix is further configured to set the first bit according to a first latency determination; and
wherein the first latency determination comprises an instruction latency determination and an execution unit latency determination.

8. A method for executing an instruction on a computer processor, comprising:
queuing an instruction in an instruction queue for execution;
storing dependency information for the instruction in a dependency matrix;
setting a first bit in a first latch coupled to the dependency matrix, the first bit corresponding to a first latency;
setting a second bit in a second latch coupled to the dependency matrix, the second bit corresponding to a second latency;
asserting a first ready signal based on the first bit;
asserting a second ready signal based on the second bit; and
scheduling the instruction for execution based on the first ready signal and the second ready signal.

9. The method of claim 8, wherein the first latency comprises a speculative latency and the second latency comprises a non-speculative latency.

10. The method of claim 8, wherein the first latency comprises an issue-to-issue latency.

11. The method of claim 8, wherein the first latency comprises an issue-to-issue latency and an execution unit latency.

12. The method of claim 8, wherein the first latency comprises a first execution unit latency and the second latency comprises a second execution latency.

13. The method of claim 8, further comprising setting the second bit based on the first ready signal.

14. The method of claim 8, further comprising:
selecting between a first execution unit and a second execution unit based on the first ready signal and the second ready signal; and
scheduling the instruction for execution based on the selection.

15. A computer program product for executing an instruction on a computer processor, the computer program product stored on a computer usable medium having computer usable program code embodied therewith, the computer useable program code comprising:
computer usable program code for queuing an instruction in an instruction queue for execution;
computer usable program code for storing dependency information for the instruction in a dependency matrix;
computer usable program code for setting a first bit in a first latch coupled to the dependency matrix, the first bit corresponding to a first latency;
computer usable program code for setting a second bit in a second latch coupled to the dependency matrix, the second bit corresponding to a second latency;
computer usable program code for asserting a first ready signal based on the first bit;
computer usable program code for asserting a second ready signal based on the second bit; and
computer usable program code for scheduling the instruction for execution based on the first ready signal and the second ready signal.

16. The computer program product of claim 15, wherein the first latency comprises a speculative latency and the second latency comprises a non-speculative latency.

17. The computer program product of claim 15, wherein the first latency comprises an issue-to-issue latency.

18. The computer program product of claim 15, wherein the first latency comprises an issue-to-issue latency and an execution unit latency.

19. The computer program product of claim 15, further comprising setting the second bit based on the first ready signal.

20. The computer program product of claim 15, further comprising:
computer usable program code for selecting between a first execution unit and a second execution unit based on the first ready signal and the second ready signal; and
computer usable program code for scheduling the instruction for execution based on the selection.
